(19) United States
(12) Patent Application Publication
(10) Pub. No.: US 2007/0282735 A1
(43) Pub. Date: Dec. 6, 2007

(54) LIEN PAYOFF SYSTEMS AND METHODS

(75) Inventor: Joseph Schuebert, Clermont, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ASSURANT, INC., New York, NY (US)

(21) Appl. No.: 11/618,407

(22) Filed: Dec. 29, 2006

Related U.S. Application Data
(60) Provisional application No. 60/754,792, filed on Dec. 29, 2005.

(51) Int. Cl. G06Q 40/00

(52) U.S. Cl. 705/38; 705/39

(57) ABSTRACT

A computer system that is adapted for facilitating the payoff of a financial obligation that is secured by a lien on an item, such as a vehicle. In various embodiments, the computer system is adapted for: (A) receiving a payoff proposal from a title requester that includes terms according to which the title requester proposes to pay off the particular financial obligation; (B) in response to receiving the payoff proposal from the title requester, notifying a lien holder associated with the financial obligation that the payoff proposal is available for review; and (C) after notifying the lien holder that the payoff proposal is available for review, displaying one or more terms of the payoff proposal to the lien holder. The system may be further configured for facilitating the electronic transfer of relevant documents and information between the title requestor, the lien holder, and/or various third parties or third party computer systems.

### CROSS-REFERENCE TO RELATED APPLICATIONS

This application claims priority from U.S. Provisional Patent Application No. 60/754,792, entitled “Lien Payoff System”, which was filed on Dec. 29, 2005, and which is hereby incorporated by reference in its entirety.

### BACKGROUND OF THE INVENTION

During the useful life of a vehicle, the vehicle's physical title is often exchanged several times between various parties, such as: (1) the dealer selling the vehicle; (2) the purchaser of the vehicle; (3) a lender providing a loan for the vehicle's purchase price (which is typically secured by the vehicle); and (4) the Department of Motor Vehicles (“DMV”). FIG. 1 depicts the typical life cycle of a vehicle title.

As shown in FIG. 1, the life cycle of a vehicle's title begins when the vehicle is assigned a Manufacturer Certificate of Origin (MCO) upon production of the vehicle. The vehicle is then sent to a dealership for sale to a customer. When the vehicle is sold to its original owner, the owner completes the applicable title and registration application forms for the vehicle and sends them to the DMV. The DMV then records these documents, issues a vehicle title, and forwards the vehicle title to the appropriate party. For purposes of this discussion, we will assume that the vehicle is used to secure a loan for the vehicle's purchase price. Under these circumstances, the vehicle's title will be sent directly to the lender.

Next, the lender receives the title and verifies that the information on the title is correct. The lender then stores the title until the vehicle loan is paid off. The loan is then ultimately paid off by either the borrower, a vehicle dealer (if the vehicle is used as a “trade in” during the purchase of another vehicle), or an insurer (if the vehicle is “totaled” in an accident). After the loan is paid off, the lender retrieves the vehicle's title from storage and releases the lien on the title. The lender then mails the title to the appropriate party (either the borrower, the dealer, or the insurer). This party then returns the title to the DMV, where the information related to the title is updated. The DMV then returns the title to the appropriate party.

Unfortunately, the current process for facilitating the payoff of a vehicle loan and the subsequent transfer of the vehicle's physical title is, at best, cumbersome, labor intensive, and time consuming. Several exemplary disadvantages of this process are discussed below from the perspective of vehicle dealers, insurers, and lenders.

Vehicle Dealers

Currently, approximately sixty percent of new and used vehicle sales involve a trade-in of the buyer's current vehicle. To conclude transactions involving a trade-in, dealers must secure information regarding the status of the vehicle being traded in, as well as information regarding any pending liens on the vehicle. This information is then used to finalize the transaction.

By law, a dealer may not sell a used vehicle until the dealer has secured title on the vehicle. Therefore, dealers are motivated to secure the information referenced above quickly in order to make the vehicle available for sale as soon as possible.

Currently, in order to pay off a lien on a particular vehicle, dealers typically must contact the appropriate lender by telephone to determine the “10-day payoff amount” of the loan that is being secured by the lien on the vehicle. This process is often labor intensive and expensive. During this manual process, telephone hold times often range from five to twenty minutes. To make matters worse, most institutions have a limit on the number of payoffs that they will provide to each caller after verifying that the caller has the right obtain the payoff information.

In addition, dealers typically send funds to pay off loans on vehicles by check, which is labor intensive and time consuming. Furthermore, after releasing a lien, lenders often take several weeks before mailing clear title to the dealer.

Accordingly, there is a need, by vehicle dealers, for systems and methods for improving the current vehicle lien payoff process.

Insurers

Currently, in order to pay off a lien on a particular vehicle, insurers typically must: (1) contact the applicable lender by telephone to determine the “10-day payoff amount” of the loan; (2) negotiate a settlement amount; (3) provide delivery instructions; and (4) obtain a “guarantee letter” from the lender. During this manual process, telephone hold times often range from five to twenty minutes. In addition, most institutions have a limit on the number of payoffs that they will provide to each caller after verifying that the caller has a right to the payoff information. Accordingly, this process is often labor intensive and expensive.

In addition, insurers typically send funds to pay off loans on vehicles by check, which is labor intensive and time consuming, and lenders must typically hold the check for 10 to 20 days to verify funds before releasing the vehicle's title. This creates a delay in salvage vehicle turnover cycle time.

Accordingly, there is a need, by insurers, for systems and methods for improving the current vehicle lien payoff process.

Lenders

Currently, during the course of the process outlined above, a lender will typically receive a paper check from a dealer or insurer who is seeking to satisfy a particular lien. Mailroom workers typically receive these checks and must normally deliver the checks under dual supervision to the lender's payoff department. The payoff department then researches the account to which to post the check. This process is labor intensive and expensive. Accordingly, there is a need, by lenders, for systems and methods for improving the vehicle lien payoff process.

### BRIEF SUMMARY OF VARIOUS EMBODIMENTS OF THE INVENTION

A lien payoff system according to various embodiments of the invention is configured to facilitate the process of receiving a physical title in exchange for paying off the balance of a loan secured by the title. For example, in one embodiment, the system may be used by insurance companies and automobile dealerships to receive vehicle titles that are subject to liens held by financial institutions.

In general, a system according to various embodiments of the invention is adapted to receive one or more payoff proposals from one or more title requesters (e.g., insurance companies or automobile dealerships). In one embodiment, each payoff proposal identifies a title subject to a lien (e.g., a vehicle title) and a lien holder (e.g., a financial institution) and includes a request that the lien holder provide the title to the title requester in exchange for the payment of a payoff amount of the loan associated with the title. The system presents the payoff proposal to the lien holder, and if the payoff proposal is acceptable to the lien holder, the lien holder approves the payoff proposal.

Upon approval of the payoff proposal, in various embodiments, the system generates a funding request on behalf of the title requester to fund the payoff amount and to transfer the funds to the lien holder. After the system receives an indication that the funds have been received by the lien holder, the lien holder sends the title to the title requester or to a third party designated by the title requester, and the system stores the date that the title is received by the title requester. According to various embodiments of the invention, the system also allows the lien holder and title requester to exchange comments associated with the payoff proposal (e.g., via a live chat session).

Furthermore, in other various embodiments, the system is configured to generate reports analyzing or summarizing statistics related to payoff proposals that have been processed by the system. For example, in one embodiment, the system is configured to generate a report showing the average length of time that payoff proposals for a particular lien holder or title requester were and/or have been pending within the system. In another embodiment, the system is adapted to provide a report showing the average length of time that payoff proposals were pending during a selected date range.

In particular, a lien payoff computer system, according to particular embodiments of the invention, is a adapted for facilitating the payoff of a financial obligation that is secured by a lien on an item. In various embodiments, the computer system is adapted for: (1) receiving a payoff proposal from a title requester, the payoff proposal comprising one or more terms according to which the title requester proposes to pay off the particular financial obligation; (2) in response to receiving the payoff proposal from the title requester, notifying a lien holder associated with the financial obligation that the payoff proposal is available for review; and (3) after notifying the lien holder that the payoff proposal is available for review, displaying one or more terms of the payoff proposal to the lien holder. In particular embodiments, the computer system is further adapted to facilitate: (A) the payoff of the financial obligation; (B) the release of a lien on a title used to secure the financial obligation; and (C) the transfer of a physical embodiment of the title to the title requestor.

One advantage of various embodiments of the invention is that these embodiments may serve to facilitate the electronic exchange of both funds to payoff a vehicle loan and vehicle title information. This may enable the lender to release a vehicle's title to an insurance company or dealer more quickly and efficiently. In turn, this may allow the insurance company or dealer to sell the vehicle more efficiently and sooner than would be possible using current methods.

### BRIEF DESCRIPTION OF THE DRAWINGS

Having thus described the invention in general terms, reference will now be made to the accompanying drawings, which are not necessarily drawn to scale, and wherein:

FIG. 1 is a flow chart that depicts an exemplary life cycle for the title of a vehicle.

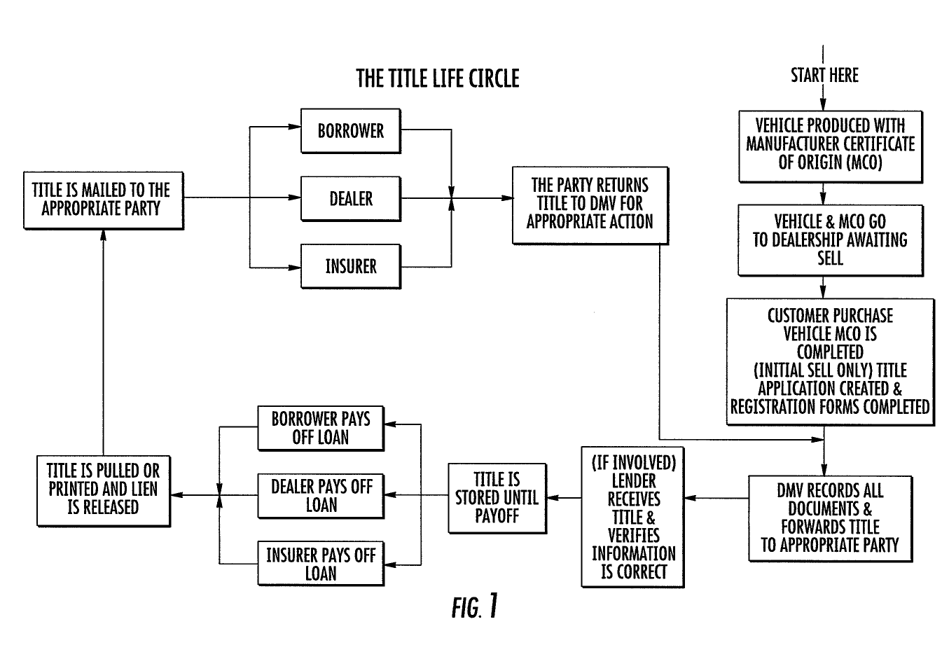

FIG. 2 is a first block diagram of a lien payoff system according to an embodiment of the present invention.

FIG. 3 is a diagram of a Lien Payoff Server according to one embodiment of the present invention.

FIG. 4 depicts the system flow of a payoff request process according to a particular embodiment of the invention.

FIG. 5 is a flowchart illustrating the steps executed by a payoff proposal processing module according to one embodiment of the invention.

FIG. 6 is a flowchart illustrating the steps executed by a login sub-module according to one embodiment of the invention.

FIG. 7 is a flowchart illustrating the steps executed by a new payoff proposal sub-module according to a particular embodiment of the invention.

FIG. 8 is a flowchart illustrating the steps executed by a view/edit payoff proposal sub-module according to one embodiment of the invention.

FIG. 9 is a flowchart illustrating the steps executed by a funding sub-module according to a particular embodiment of the invention.

FIG. 10 is a flowchart illustrating the steps executed by a title transfer sub-module according to one embodiment of the invention.

FIG. 11 is a flowchart illustrating the steps executed by a reporting module according to one embodiment of the invention.

FIG. 12 is a flowchart illustrating the steps executed by a billing module according to one embodiment of the invention.

FIG. 13 is a graphic illustration of an exemplary login dialog window for logging into the lien payoff system according to a particular embodiment of the invention.

FIG. 14A is a graphic illustration of an exemplary main menu dialog window for selecting a function of the lien payoff system available to a lien holder.

FIG. 14B is a graphic illustration of an exemplary main menu dialog window for selecting a function of the lien payoff system available to a title requester.

FIG. 15A is a graphic illustration of an exemplary outstanding submissions dialog window for viewing and editing pending payoff proposals.

FIG. 15B is a graphic illustration of an exemplary chat symbol legend for displaying various chat symbols that may, for example, be displayed in the “Chat” column shown in FIG. 15A.

FIG. 16A is a graphic illustration of an upper portion of an exemplary lien payoff proposal dialog window for viewing a summary of the particular pending payoff proposal selected by the user and entering and viewing comments about the particular payoff proposal according to one embodiment of the invention.

FIG. 16B is a graphic illustration of a lower portion of the exemplary lien payoff proposal dialog window shown in FIG. 16A for viewing and/or editing various text boxes associated with various pieces of information related to the payoff proposal.

FIG. 17 is a graphic illustration of an exemplary completed submissions dialog window for viewing completed payoff proposals according to one embodiment of the invention.

FIG. 18 is a graphic illustration of an exemplary summary of completed submissions dialog window for viewing and filtering summary statistics for completed payoff proposals according to one embodiment of the invention.

FIG. 19A is a graphic illustration of an upper portion of an exemplary new payoff proposal dialog window for entering information for a new payoff proposal according to one embodiment of the invention.

FIG. 19B is a graphic illustration of a lower portion of the exemplary new payoff proposal dialog window shown in FIG. 19A for entering information for a payoff proposal.

### DETAILED DESCRIPTION OF VARIOUS EMBODIMENTS OF THE INVENTION

The present invention will now be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

As will be appreciated by one skilled in the relevant field in view of this disclosure, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

Various embodiments of the present invention are described below with reference to block diagrams and flowchart illustrations of methods, apparatuses (e.g., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

System Architecture

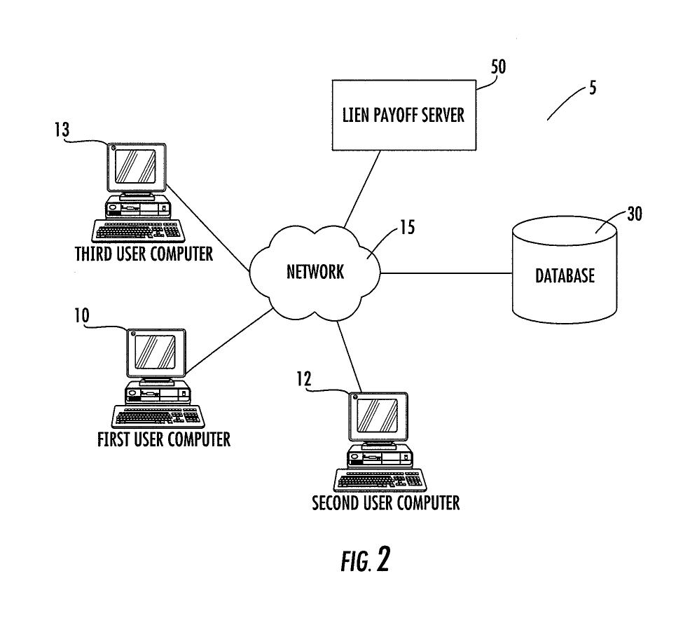

A lien payoff system 5 according to one embodiment of the invention is shown in FIG. 2. As may be understood from this figure, in this embodiment, the system includes one or more user computers 10, 12, 13 that are connected, via a network 15 (e.g., a LAN or the Internet), to communicate with a Lien Payoff Server 50. In a particular embodiment, the first user computer 10 is a computer associated with a title requestor and the second user computer 12 is a computer associated with a lien holder. In one embodiment of the invention, the lien payoff system 5 is configured for retrieving data from and storing data to a database 30 that may be stored on (or, alternatively, stored remotely from) the Lien Payoff Server 50.

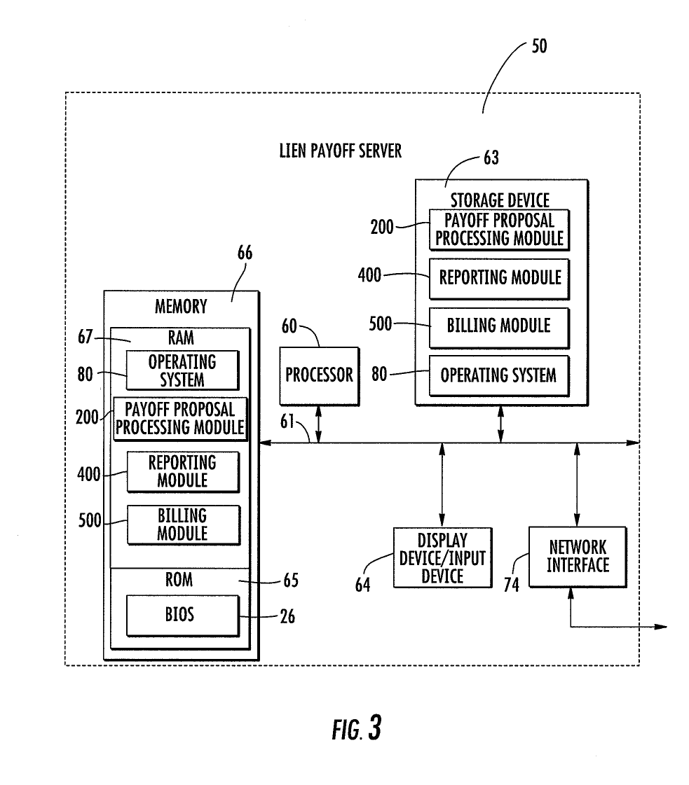

FIG. 3 shows a schematic diagram of a lien payoff server 50 according to one embodiment of the invention. The lien payoff server 50 includes a processor 60 that communicates with other elements within the lien payoff server 50 via a system interface or bus 61. Also included in the lien payoff server 50 is a display device/input device 64 for receiving and displaying data. This display device/input device 64 may be, for example, a keyboard or pointing device that is used in combination with a monitor. The lien payoff server 50 further includes memory 66, which preferably includes both read only memory (ROM) 65 and random access memory (RAM) 67. The server's ROM 65 is used to store a basic input/output system 26 (BIOS), containing the basic routines that help to transfer information between elements within the lien payoff server 50.

In addition, the lien payoff server 50 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80, a payoff proposal processing module 200, a reporting module 400, and a billing module 500. The payoff proposal processing module 200, the reporting module 400, and the billing module 500 control certain aspects of the operation of the lien payoff server 50, as is described in more detail below, with the assistance of the processor 60 and an operating system 80.

Also located within the lien payoff server 50 is a network interface 74, for interfacing and communicating with other elements of a computer network. It will be appreciated by one of ordinary skill in the art that one or more of the lien payoff server 50 components may be located geographically remotely from other lien payoff server 50 components. Furthermore, one or more of the components may be combined, and additional components performing functions described herein may be included in the lien payoff server 50.

Brief Overview of Exemplary System Flow

As mentioned above, a lien payoff system according to various embodiments of the invention is configured to automate the process of receiving a physical title in exchange for paying off the balance of a loan (or other financial obligation) secured by the title. For example, in one embodiment, the system may be used by insurance companies and automobile dealerships to receive vehicle titles that are subject to liens held by financial institutions.

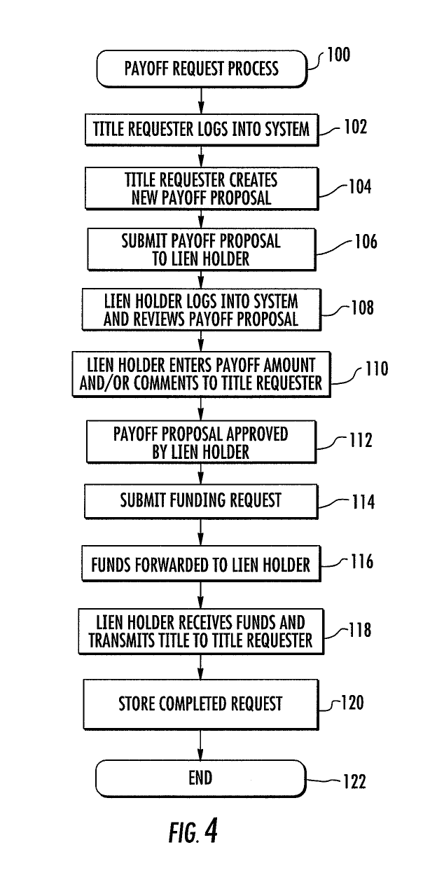

FIG. 4 illustrates an exemplary flow of the lien payoff process 100 according to various embodiments of the invention. Beginning at Step 102, a title requester logs onto the lien payoff system. Next, at Step 104, the title requester enters information that is used to create a new payoff proposal. In the context of paying off a loan for a vehicle, the information for the new payoff proposal may include, for example, the identification of the lien holder, the identification of the vehicle, the actual cash value of the vehicle, the title requester's tracking number (e.g., a claim number assigned by an insurance company that is paying off the loan), and title delivery instructions. Next, at Step 106, the new payoff proposal is submitted to the lien holder.

At Step 108, the lien holder logs into the system and views any payoff proposals that have been submitted to the system and that identify the lien holder. Next, at Step 110, the lien holder (e.g., via an employee of the lien holder) selects and reviews one of the pending payoff proposals. The lien holder may then enter the payoff amount for the loan or other financial obligation associated with the selected payoff proposal and/or enter comments (e.g., in the form of statements, requests, or questions) for the title requester. Next, if the payoff proposal is in condition for approval, the lien holder may approve the payoff proposal as shown in Step 112. In response to the approval of the payoff proposal, the system generates a funding request and submits the funding request to the funding agency as shown in Step 114. The funding agency may be, for example, ADP or other financial institution that holds funds on behalf of the title requester.

At Step 116, the funding agency (e.g., ADP or other financial institution) forwards the payoff amount to the lien holder. After the funds are received by the lien holder, the lien holder transmits the title to the title requester as shown in Step 118. Finally, as shown in Step 120, according to one embodiment, after the title is received by the title requester, the payoff proposal is stored for a certain period of time after the payoff proposal is completed (e.g., for two years), allowing the title requester, lien holder, and system administrator to access the completed payoff proposal during that time period. The lien payoff process 100 ends at Step 122.

Detailed Description of Exemplary System Flow

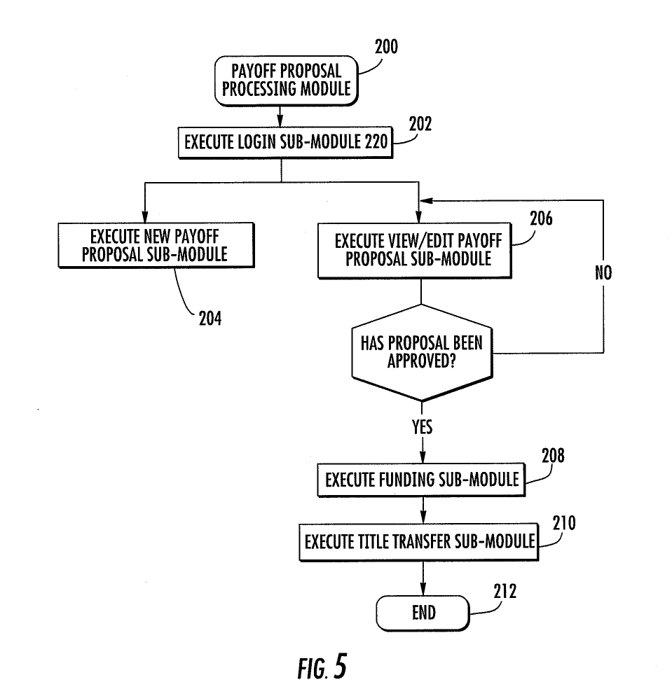

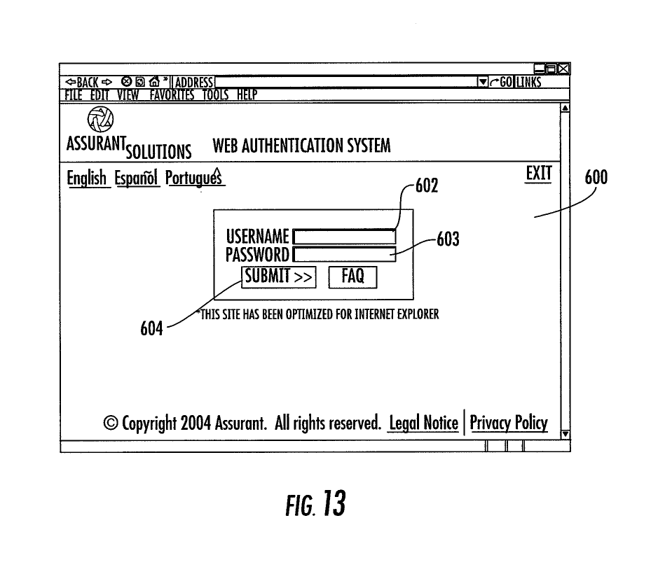

As discussed above in relation to FIG. 3, the lien payoff server 50 according to various embodiments of the invention includes: (1) a payoff proposal processing module 200, which automates the process of receiving a title in exchange for paying off the balance of a loan associated with the title; (2) a reporting module 400, which provides users with the ability to manage and analyze their pending and completed payoff proposals; and (3) a billing module 500, which automates the billing and collection process. These modules are discussed below in more detail in relation to FIGS. 5-12. In addition to including the above-mentioned modules, one embodiment of the lien payoff system 5 further includes various graphical user interfaces that facilitate the entry of information into the lien payoff system 5 and allow users to view information for pending and completed payoff proposals that have been entered into and/or processed by the lien payoff system 5. Exemplary graphical user interfaces that may be displayed by the lien payoff system 5 are discussed below in relation to FIGS. 13-19B.

Payoff Proposal Processing Module

FIG. 5 illustrates an exemplary flow of a payoff proposal processing module 200 according to one embodiment of the invention. Beginning at Step 202, the payoff proposal processing module 200 executes a login sub-module 220 that may be adapted to: (1) receive and process login information entered by users having existing accounts; and (2) set up new accounts for new users. In various embodiments, when an existing user logs into the system, the system first determines whether the user is a title requester or a lien holder. According to one embodiment, the login sub-module 200 recognizes the type of user by receiving the user's login information and retrieving the type of user associated with the login information from a database. According to one embodiment, the system 5 may base the options displayed to the user on whether the user is a title requester, a lien holder, or a system administrator. For example, if the system recognizes the user as a title requester, the payoff proposal processing module 200 presents the user with the option of entering new payoff proposals. Similarly, if the system recognizes the user as a lien holder, the payoff proposal processing module 200 presents the user with the option of approving pending payoff proposals.

According to one embodiment, if the user is a title requester and selects the option of entering a new payoff proposal, at Step 204, the payoff proposal processing module 200 executes a new payoff proposal sub-module 240. In various embodiments, the new payoff proposal sub-module 240 allows the user to enter information that is used to create a new payoff proposal and to submit the new payoff proposal to the appropriate lien holder.

The payoff proposal processing module 200 may also allow the title requester, at Step 206, to view and edit pending payoff proposals by executing the view/edit payoff proposal sub-module 260. In addition to allowing the user to view and edit payoff proposals, the view/edit payoff proposal sub-module 260 according to one embodiment is configured to receive comments from the user that can be reviewed by one or more other parties associated with the loan at issue. Furthermore, in various embodiments, the view/edit payoff proposal sub-module 260 allows the lien holder to approve (and, in various embodiments decline) the payoff proposal.

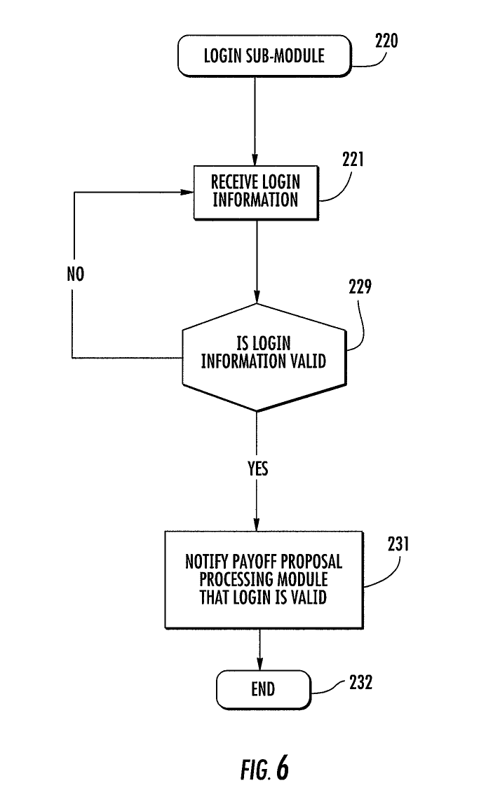

In various embodiments, if the payoff proposal is approved by the lien holder, the payoff proposal processing module 200 proceeds to Step 208 where it executes a funding sub-module 290. In one embodiment, the funding sub-module 290 is configured, for example: (1) to generate a request to transfer funds to the lien holder; (2) receive acknowledgement or confirmation that the funds have been transferred to the lien holder; and/or (3) update the current status of the payoff proposal (e.g., by updating information within the system's database 30). After updating the status of the payoff proposal to reflect receipt of the funds by the lien holder, the payoff proposal processing module 200 may execute a title transfer sub-module 210, which may, for example, facilitate the transfer and/or the documentation of the transfer of the title from the lien holder to the title requester. Each of the above mentioned steps and sub-modules are discussed in greater detail below in regard to FIGS. 6-10.

Login Sub-Module

FIG. 6 illustrates an exemplary flow of a login sub-module 220 according to one embodiment of the invention. In this embodiment, the login sub-module 220 begins by determining whether the user is a new or existing user. If the user is a new user, the login sub-module 220 receives information used to establish an account with the lien payoff system 5 from the user and/or a system administrator. This information may include, for example, the user's: (1) user ID; (2) password; (3) name and address; (4) user type (e.g., title requester, lien holder, or system administrator); (5) preferred method of moving funds or transferring title documents; (6) preferred method of calculating actual cash value; and/or (7) preferred method of being billed by the system. In addition, the information may include one or more rules to be used by the system in automatically approving incoming payoff proposals. For example, such rules may establish that if a vehicle's actual cash value is greater than or within a certain tolerance of the payoff amount of a corresponding vehicle loan that is the subject of a particular proposal, the system should automatically approve the payoff proposal).

In various embodiments, the new user provides at least a portion of the above information to a system representative via email, telephone, fax, or in-person, and the system representative enters the information into the system to set up the new user's account. In another embodiment, the new user enters at least a portion of the information into the system (e.g., via a dialog window presented by the login sub-module 220). In a further embodiment, information for the new user is provided by a customer-service administrator, such as an administrator associated with a particular insurance company or financial institution.

Next, at Step 221, the login sub-module 220 receives login information from the user via a dialog window displayed by the system (see, for example, FIG. 13). The system then advances to Step 229, where the login sub-module 220 evaluates the received login information to determine whether the login information is valid (e.g., by determining whether the login information corresponds to that of a valid user within the database). If the login information is not valid, the user may attempt to re-enter the login information. If the login information is valid, the login sub-module 220 notifies the payoff proposal processing module 200 that the login was successful at Step 231, and the login sub-module 220 ends at Step 232.

Main Menu Display

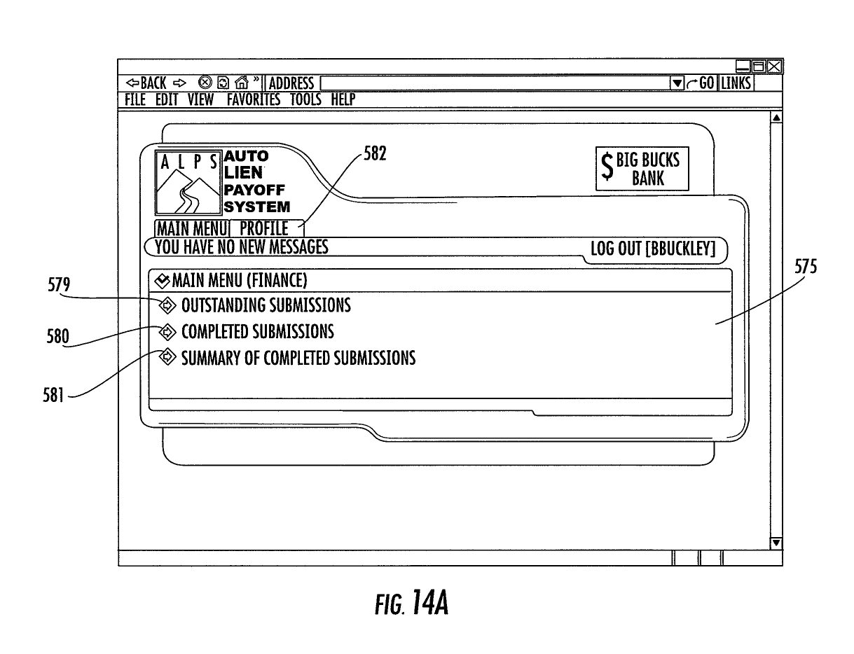

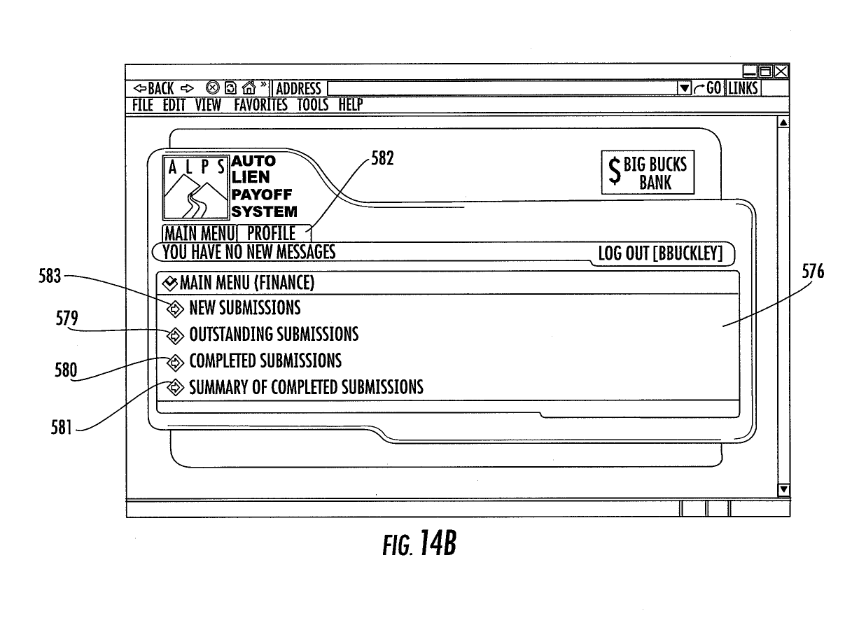

Returning to FIG. 5, according to one embodiment of the invention, if the payoff proposal processing module 200 receives an indication from the login sub-module 220 that the login is successful, the payoff proposal processing module 200 displays a main menu dialog window that provides the user with the options of: (1) viewing, editing and/or approving pending payoff proposals; (2) viewing completed requests; (3) creating and viewing summary reports on payoff proposals; and/or (4) changing the user's account settings and preferences. Exemplary main menu dialog windows are discussed below in relation to FIGS. 14A and 14B. In a particular embodiment, the main menu dialog window presented to a title requester and a lien holder are substantially the same, and the main menu dialog window “grays out” (e.g., makes unavailable for selection) options that the type of user at issue does not have permission to execute. For example, the main menu dialog window may present the option of creating new payoff proposals if the user is a title requester, but not if the user is a lien holder.

New Payoff Proposal Sub-Module

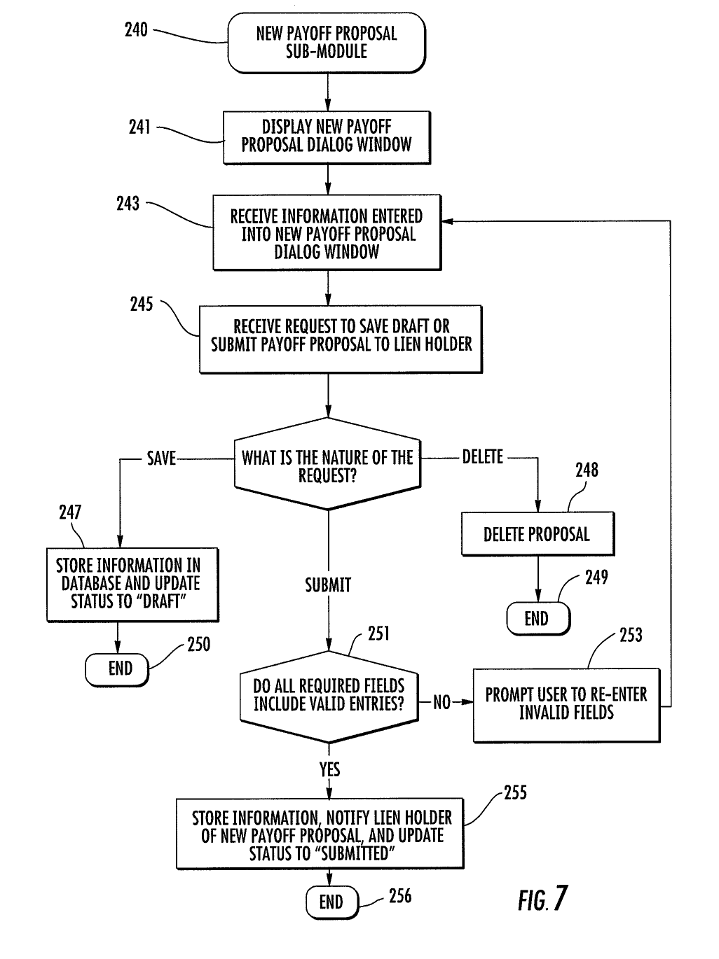

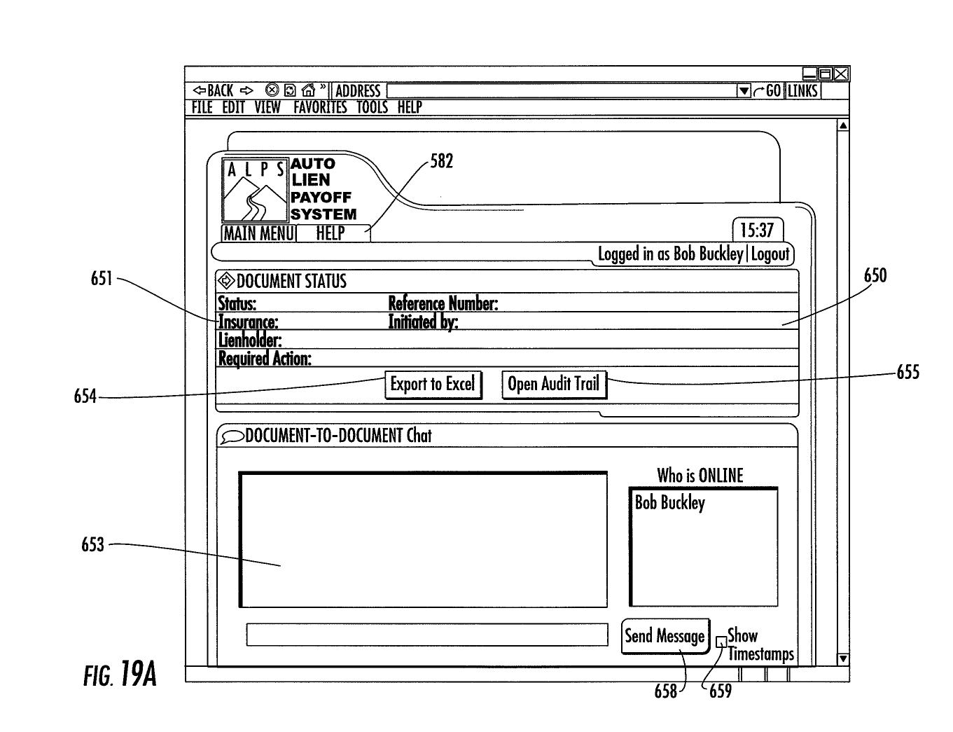

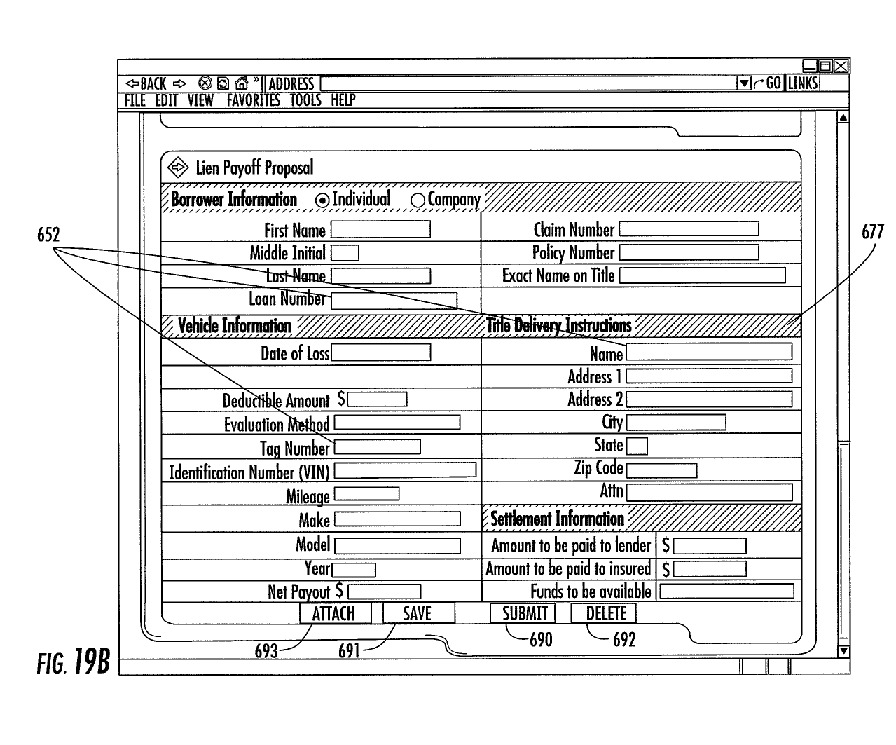

In various embodiments, in response to a user (e.g., a title requester) selecting the option of entering a new payoff proposal, the payoff proposal processing module 200 executes the new payoff proposal sub-module 240 (see FIG. 7). As shown in FIG. 7, an exemplary flow of a new payoff proposal sub-module 240 begins at Step 241 by displaying a new payoff proposal dialog window to the user. (An exemplary new payoff proposal dialog window is shown in FIGS. 19A and 19B.) Next, the user enters information for the new payoff proposal into the new payoff proposal dialog window, and this information is received by the new payoff proposal sub-module 240 at Step 243. Information received by the new payoff proposal sub-module 240 may include, but is not limited to, the following: (1) lien holder; (2) name of the insured; (3) date of loss of an item (e.g., a vehicle) subject to the lien; (4) deductible amount for the item that is subject to the lien; (5) evaluation method used to determine the actual cash value (ACV) of the item; (6) an identification number associated with the item (e.g., a VIN for vehicle); (7) if the item is a vehicle, the vehicle's mileage, make, model, and/or year of manufacture; (8) the ACV of the item; (9) the title requester's tracking number (e.g., a claim number for an insurance company); (10) other internal reference numbers; (11) a policy or other tracking number associated with the item; and/or (12) title delivery instructions (e.g., the name of the entity to receive the title, the entity's address, and an indication of particular personnel within the entity to receive the title).

In alternative embodiments, the new payoff proposal sub-module 240 is configured to interface with a private external system, such as an insurance company's claim processing system, to receive various information used to create a new payoff proposal. For example, in various embodiments, the new payoff proposal sub-module 240 may be configured to interface with a private external system to receive, for example, (1) the actual cash value (ACV) of the item at issue (e.g., a vehicle); (2) a deductible amount associated with the item; (3) other information regarding the item; and/or (4) the name and address of the insured. In various embodiments, the new payoff proposal sub-module 240 is configured to retrieve this information automatically (e.g., based on a vehicle's VIN, or the title requester's policy number).

Furthermore, in various embodiments, the new payoff proposal sub-module 240 is configured to receive images and/or other information relating to existing claims that are stored within one or more public systems that are external to the lien payoff system 5. Similarly, in various alternative embodiments, the new payoff proposal sub-module 240 is configured to interface with a public data storage system (e.g., a computer system maintained by a government agency) to receive information that can be used to populate one or more fields in the new payoff proposal dialog window automatically. For example, in one embodiment, the new payoff proposal sub-module 240 is configured to receive the make, model, year, owner, owner address, tag number and description of a vehicle from a Department of Motor Vehicle (DMV) computer system based on the VIN of the vehicle.

In addition, according to various embodiments, the new payoff proposal sub-module 240 is configured to allow the title requester to attach one or more documents to the new payoff proposal (e.g., for later viewing by the lien holder). Such documents may include, for example, a copy of a title of a vehicle, or a guarantor's letter.

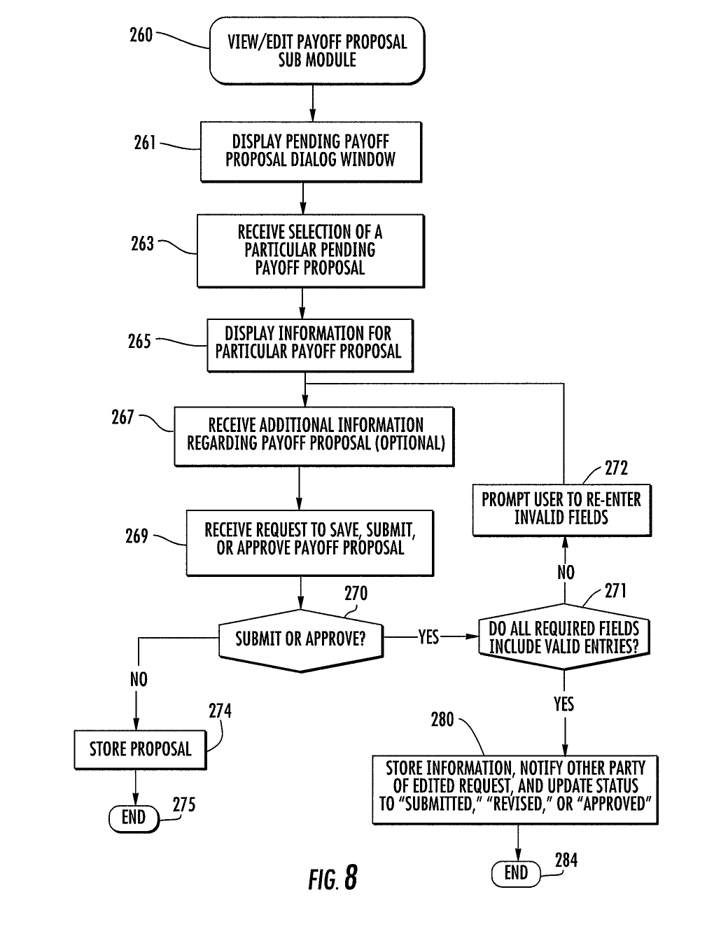

Returning to FIG. 7, after the system receives information via the new payoff proposal dialog window, at Step 245, the system may receive a request from the user to: (1) save the draft of the payoff proposal; (2) submit the payoff proposal to the lien holder; or (3) delete the payoff proposal. Next, at Step 246, the system determines whether the user indicated that they wanted to save, delete, or submit the current payoff proposal. If the user requested to delete the payoff proposal, the system deletes the payoff proposal and ends at Step 249. If the user requests to save a draft of the payoff proposal, the system proceeds to step 247 where it stores the information and updates the status of the payoff proposal to “Draft” (indicating that the payoff proposal has been started by the user but has not yet been submitted to the lien holder). Next, at Step 250, the system ends execution of the new payoff proposal sub-module 240. As discussed below in relation to FIG. 8, in this situation, the system preferably allows the user to continue editing the draft payoff proposal at a later time.

If, at Step 246, the system determines that the user requested to submit the payoff proposal to the lien holder, the new payoff proposal sub-module 240 proceeds to Step 251 where it determines whether all of the information entered into the new payoff proposal dialog window is valid. For example, the system may determine whether the data entered into one or more of the fields of the new payoff proposal dialog window satisfies pre-determined criteria for that field. If any of the information entered is determined to be invalid, at Step 253, the new payoff proposal sub-module 240 prompts the user to re-enter the information into the appropriate fields. The system then repeats Steps 243, 245, and 246 until all of the information is valid (or until the user deletes the payoff proposal, or saves a draft of the proposal for later processing).

Next, once the system determines that all of the required fields include valid entries, the system advances to Step 255 where it stores the information in the system's database, updates the status of the payoff proposal to “Submitted”, and optionally notifies the lien holder to which the request is directed that a new request has been submitted. In various embodiments, this notification may be executed via email, an automated telephone call, or a facsimile transmission. In addition, in certain embodiments, updating the status of the payoff proposal to “Submitted” serves to indicate that the payoff proposal has been submitted to the lien holder, but that the lien holder has not seen it. At Step 256, the system ends execution of the new payoff proposal sub-module 240.

View/Edit Payoff Proposal Sub-Module

As mentioned above in regard to FIG. 5, in various embodiments, in response to a user (e.g., a lien holder—via a lien holder representative, or a title requestor—via a title requester representative) selecting the option of viewing and editing pending payoff proposals, the system executes a view/edit payoff proposal sub-module 260. FIG. 8 illustrates an exemplary flow of a view/edit payoff proposal sub-module 260 according to one embodiment of the invention. Turning to this figure, when executing an exemplary view/edit payoff proposal sub-module 260, the system first advances to Step 261 where it displays a pending payoff proposal dialog window that lists any payoff proposals that are pending for the user or the company associated with the user. For example, if the user is associated with a title requester, a list of pending payoff proposals that have been drafted and submitted by users (e.g., all users) associated with the particular title requester may be displayed. Similarly, if the user is associated with a lien holder, a list of pending payoff proposals that have been submitted for processing by the particular lien holder is displayed. In various embodiments, if the user is a system administrator, a list of all pending payoff proposals is displayed. In various alternative embodiments, the view/edit payoff proposal sub-module 260 can be configured to display only the payoff proposals that have been drafted by, commented on by, and or specifically directed to the particular user.

Next, at Step 263, the system receives a selection of a particular payoff proposal from the user. In one embodiment, the user may select a particular payoff proposal by selecting (e.g., clicking on), for example: (1) the title requester's internal tracking number (e.g., claim number, loan number, or other internal reference number); (2) the system's reference number associated with the payoff proposal; or (3) the vehicle owner's/lessee's name.

Upon receiving a selection of a particular payoff proposal, the system proceeds to Step 265, where it displays information related to the particular payoff proposal (e.g., via a View/Edit Payoff Proposal screen). In various embodiments, the user may then add additional information to the payoff proposal (e.g., by entering the necessary information into a GUI screen) depending on whether all of the information needed for the payoff proposal is included in the displayed payoff proposal. Alternatively, the user may simply review the payoff proposal without making any changes. If the user adds additional information to the payoff proposal, the system advances to Step 267 where it receives the additional information for the payoff proposal from the user.

In various embodiments, while viewing and entering information on the system's View/Edit Payoff Proposal screen, the user may enter a request (e.g., via a GUI screen) to save the current draft of the payoff proposal, submit the payoff proposal to another party associated with the current payoff proposal, or, if the user is a lien holder, approve the payoff proposal. In one embodiment, the system receives the user's request at Step 269. If the user chooses to save the payoff proposal, the system proceeds to Step 274 where it saves the current payoff proposal. The system then ends execution of the view/edit payoff proposal sub-module 260 at Step 275.

However, if the user requests to submit (or re-submit), or approve the payoff proposal, the system proceeds to Step 271 where the system verifies that all of the required fields include valid entries. If any of the fields does not include a valid entry, the system advances to Step 272 where it prompts the user to re-enter information as needed. The system then repeats Steps 267, 269, and 271 until all of the required fields include valid entries (or until the user saves the entry without resubmitting or approving it). When the system determines that all of the required fields include valid entries, the system proceeds to Step 280 where it stores the updated payoff proposal, notifies (e.g., via email, automated telephone call, or facsimile transmission) one or more other parties associated with the payoff proposal that a new or re-submitted request has been received, and updates the status of the payoff proposal. According to one embodiment, if the payoff proposal is being submitted for the first time to the lien holder, the system updates the status of the payoff proposal to “Submitted,” and if the payoff proposal is being resubmitted to the other party, the status is updated to “Revised.” If the payoff proposal is approved, the status is updated to “Approved.” Finally, the system ends execution of the view/edit payoff proposal sub-module 260 at Step 284.

As noted above, in addition to allowing the user to enter information manually, in various embodiments, the view/edit payoff proposal sub-module 260 is configured to interface with existing external data storage systems to receive information that can be included in the payoff proposal automatically. The system may then use this information to automatically populate one or more fields in a database associated with the payoff proposal.

For example, in one embodiment, the view/edit payoff proposal sub-module 260 is configured to receive a payoff amount and/or loan/lease number associated with a particular proposal from a computer system associated with the lien holder to whom the proposal will be submitted. This information may be retrieved from the lien holder's computer system, for example, based on the vehicle identification number (VIN) of a vehicle associated with the payoff proposal, or other identifying criteria. As another example, the view/edit payoff proposal sub-module 260 may be configured to receive one or more of the following from the lien holder's system: (1) the actual cash value (ACV) amount of an item associated with the current payoff proposal; (2) a deductible amount associated with the proposal; (3) the name and/or address of an insured party associated with the proposal; (4) the owner of an item (e.g., vehicle) that is the subject of the proposal; and (5) a loan/lease number associated with the proposal. In various embodiments, this information may be retrieved from the lien holder's system based on an item identification number associated with an item that is the subject of the proposal (e.g., a VIN number of a particular vehicle).

In another embodiment of the invention, the view/edit payoff proposal sub-module 260 is configured to prevent a user from entering certain types of information by, for example, graying out the fields for entering certain information, not displaying the fields for entering certain information, or displaying the fields for the certain information but not storing any entries or edits made by the unauthorized user. For example, if the user is a title requester, the view/edit payoff proposal sub-module 260 may be configured to prevent the user from entering or editing a payoff amount or a loan/lease number for a payoff proposal. As another example, if the user is a lien holder, the view/edit payoff proposal sub-module 260 may be configured to prevent the user from entering or editing a deductible amount associated with the payoff proposal.

In addition, in various embodiments of the invention, the view/edit payoff proposal sub-module 260 may be configured to receive comments from a user for display (e.g., later display) to other users who are viewing a particular payoff proposal. These comments may include, for example: (1) instructions regarding the date the funds will be available; (2) questions regarding where to transfer the funds or the title; (3) questions regarding certain field entries; (4) requests for additional information; and/or (5) requests to view and/or receive copies of, certain documents, such as a copy of the title at issue or a copy of a guarantor's letter.

In one embodiment, upon receiving a comment from a user, the view/edit payoff proposal sub-module 260 associates the comment with the identification of the user that entered the comment and/or a date/time stamp indicating the date and time at which the comment was entered into the system, and stores the comment in a database. In one embodiment, the user identification and date and time stamp can be used for tracking or management purposes.

In various embodiments of the invention, the view/edit payoff proposal sub-module 260 is adapted to display any comments associated with a particular payoff proposal each time the proposal is displayed by the view/edit payoff proposal sub-module 260. In various embodiments, the system is adapted to display the name of the title holder associated with the proposal (e.g., the name of the vehicle owner or lessee) with each comment.

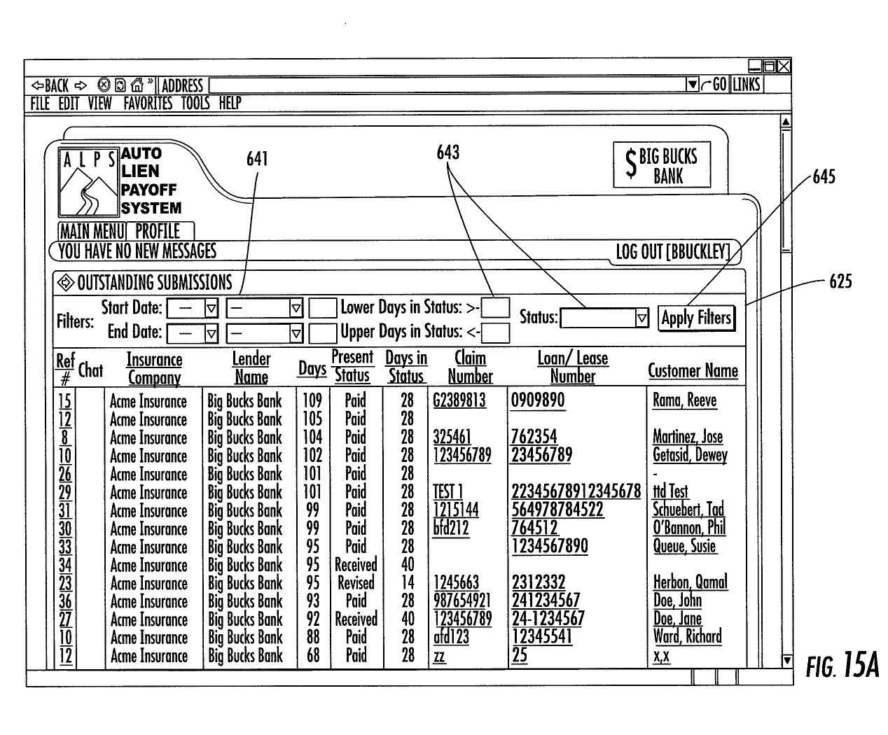

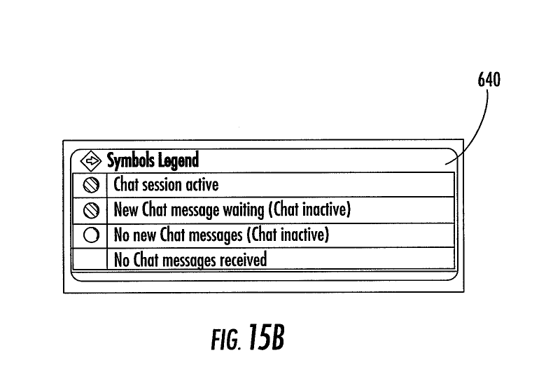

Furthermore, as discussed below in regard to FIG. 15B, the system may display a chat symbol adjacent a visual indicia associated with the particular payoff proposal to indicate that a comment has been entered for the particular payoff proposal and is available for display to the user. In addition, the system may automatically notify another party associated with the payoff proposal (e.g., via email, facsimile, or phone) when a new comment is posted to the system in regard to the payoff proposal.

Furthermore, in various embodiments, the view/edit payoff proposal sub-module 260 is configured to allow a user to electronically “attach” one or more documents selected by the user to the payoff proposal. For example, the system may be configured to allow a lien holder to attach a copy of a title or a guarantor's letter associated with the payoff proposal for later display to the title requester when the title requester views the payoff proposal. This may serve to expedite processing of the payoff proposal.

Funding Sub-Module

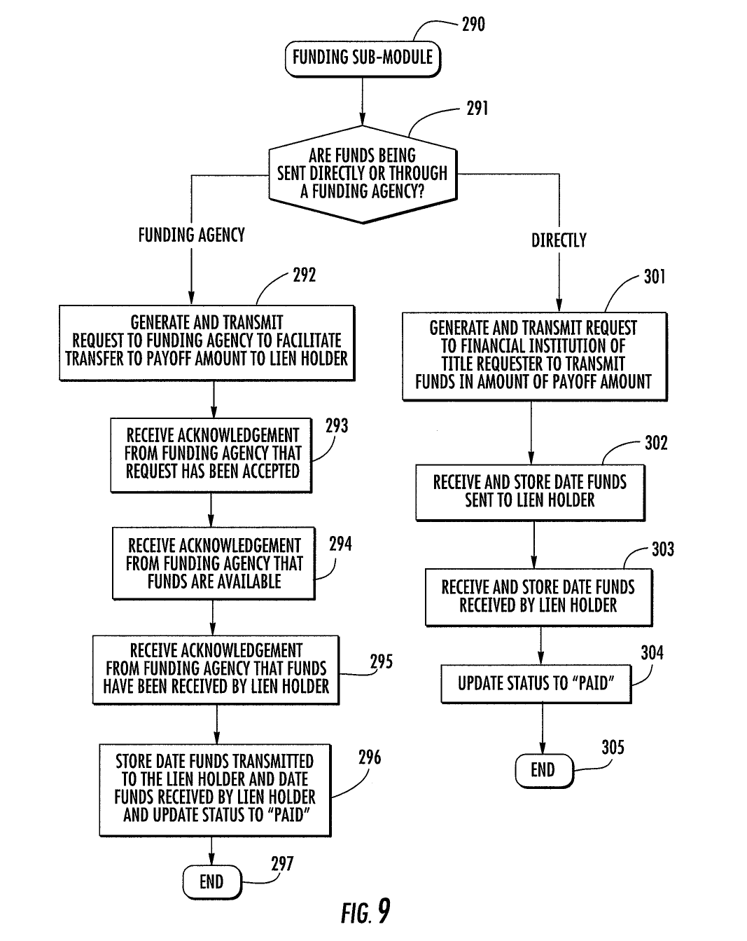

Returning to FIG. 5, once the proposal has been approved, the system advances to Step 208, where it executes a funding sub-module 290, an exemplary embodiment of which is illustrated in FIG. 9. When executing the funding sub-module shown in FIG. 9, the system first advances to Step 291, where it determines whether the payoff funds specified within the payoff proposal are to be sent directly to the lien holder from the title requester, or whether the funds are to be transferred through a funding agency, such as ADP.

As noted above, in various embodiments of the invention, the title requester can select how funds should be transferred when setting up the title requester's account settings, which may, for example, affect all payoff proposals submitted by the title requester. In another embodiment, the system is configured to allow a user to specify, on a proposal-by-proposal basis, whether the payoff funds specified within the payoff proposal are to be sent directly to the lien holder from the title requester, or whether the funds are to be transferred through a funding agency. In yet another embodiment, the title requester can configure their account settings to establish a default setting as to how funds should be transferred, and maintain the option of manually overriding this default setting for each particular payoff proposal.

Returning to FIG. 9, in various embodiments, if funds are to be transferred to the lien holder through a funding agency, the system advances to Step 292 where it generates and transmits a funding request (e.g., an electronic or paper funding request) to the appropriate funding agency. This request may include, for example, a request that the funding agency transfer the payoff amount directly to the lien holder. (The funding agency that is to receive the funding request may, for example, be selected by the user or by the lien payoff system.) Furthermore, the funding request may also include, for example: (1) the identity of the lien holder; (2) the lien holder account to which the funds should be transferred or the address where the funds should be sent; (3) a loan or lease number to reference along with the transfer of funds; (4) an identification of the title requester; and/or (5) an identification of the account (e.g., an account number) from which the funds should be paid.

In various embodiments, after the funding request has been transmitted to the funding agency, the system advances to Step 293 where it receives an acknowledgement from the funding agency that the funding request has been received and accepted by the funding agency. Next, at Step 294, the system receives acknowledgement from the funding agency that the funds are available for transfer to the lien holder. After the funds are verified as being available for transferring to the lien holder, the funding agency transfers the funds to the lien holder, and the system receives acknowledgement from the funding agency that the funds have been transferred to and received by the lien holder as shown in Step 295. Next, at Step 296, the system stores the dates that the funds were transferred to, and received from, the lien holder and stores this information in the system's database. In addition, the system updates the status of the payoff proposal to “Paid.” The system then ends execution of the funding sub-module at Step 297.

According to one embodiment, the funding sub-module 290 is configured to interface with the funding agency's system to receive the acknowledgements discussed above automatically. In another embodiment, the funding sub-module 290 is configured to receive a batch file from the funding agency on a periodic basis (e.g., daily). Such a batch file may, for example, include all of the above mentioned acknowledgements for a particular day or other predetermined time period.

Returning to Step 291 in FIG. 9, in various embodiments, if the funds are to be transmitted directly to the title requester from the lien holder, the system advances to Step 301 where it generates and transmits a funding request to a financial institution specified by the title requester. This request may, for example, request that funds in the amount of the payoff amount be transferred directly to the lien holder, or to an account specified by the lien holder. The request may include, for example: (1) the identity of the lien holder; (2) the lien holder account into which the funds are to be transferred, or the address where the funds should be sent; (3) a loan or lease number to associate with the fund transfer; (4) the identification of the title requester; and (5) the identification of the account from which the funds should be paid.

Next, at Steps 302 and 303, the system receives the date that the funds were sent to the lien holder and the date the funds were received by the lien holder. The system may receive this information, for example, directly from the title requester or from an external system. Upon receiving the dates that the funds were sent to and received by the lien holder, the system advances to Step 304, the system stores these dates in the system's database and updates the status of the payoff proposal to “Paid”. Finally, the system ends processing of the funding module at Step 305.

Title Transfer Sub-Module

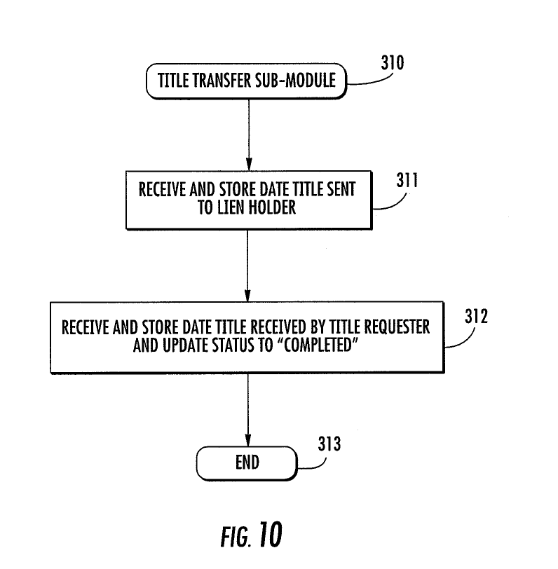

In various embodiments, in response to the status of the payoff proposal being updated within the system as having been paid, the system's payoff proposal processing module 200 executes a title transfer sub-module 310, an exemplary embodiment of which is shown in FIG. 10. In this embodiment, the system begins executing the title transfer sub-module 310 at Step 311 where it receives and stores the date the title was sent from the lien holder to the title requester. The system may receive this information via manual entry (for example, by the lien holder after the lien holder sends the title to the title requester), or electronically (e.g., from the lien holder's computer system). Next, in Step 312, the system receives and stores the date the title was received by the title requester. The system may receive this information via manual entry (for example, by the title requester after the title requester receives the title from the title requester), or electronically (e.g., from the title requester's computer system). The system then updates the status of the payoff proposal to “Completed.” The title transfer sub-module 310 ends at Step 313.

Reporting Module

As discussed above in relation to FIG. 2, in various embodiments, the system includes a reporting module 400 that allows users to view and analyze pending and completed payoff proposals. A reporting module 400 according to one embodiment provides users with the ability to assess the performance of various users of the system.

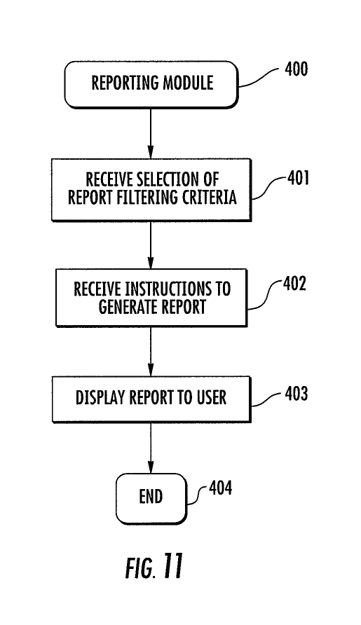

FIG. 11 illustrates an exemplary flow of a reporting module 400 according to one embodiment of the invention. When executing a reporting module 400 according to this embodiment, the system advances to Step 401, where it receives report filtering criteria from the user. This report filtering criteria may, for example, be configured to allow a user to sort proposals by: (1) date; (2) type; (3) status; (4) title requester; (5) lien holder; and/or (6) number of days pending. The system may also receive a request by the user to include specific information on the report (e.g., the number of days elapsed for each pending payoff proposal and/or the average number of days that the payoff proposals have been pending). Next, at Step 402, the system receives instructions to generate the report. Finally, the reporting module 400 generates the requested report and displays the report to the user in Step 403. The system then ends execution of the reporting module 400 at Step 404.

In one embodiment, the reporting module 400 is configured to receive instructions from the user to sort the results displayed by selecting a particular field, such as by: (1) status; (2) lien holder or title requester; (3) date of submission; (4) number of days in present status; (5) the time elapsed since submission; and (6) users that are associated with the payoff proposal. The information can be sorted in ascending order or descending order, and the user may select the heading of a field to alternate between ascending order and descending order, for example.

Billing Module

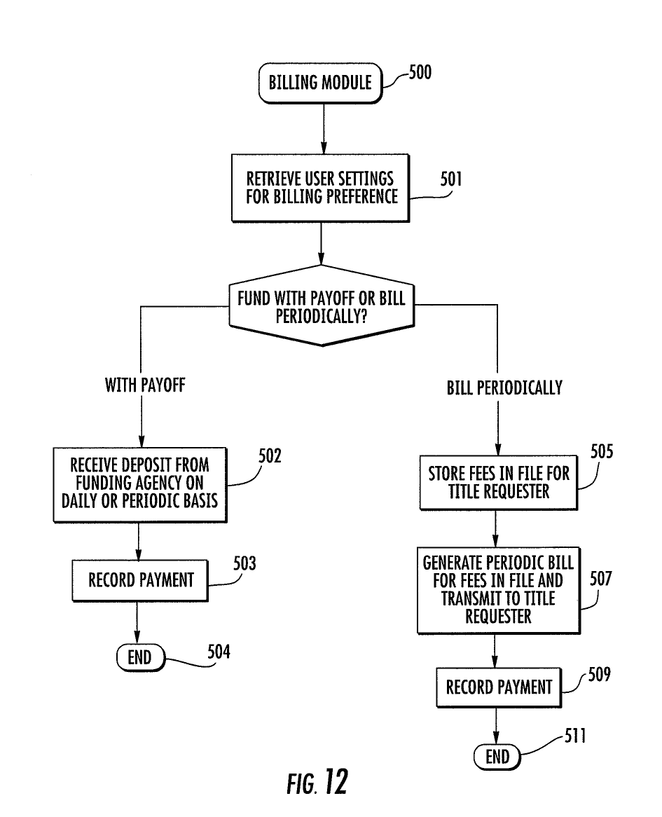

FIG. 12 illustrates an exemplary flow of a billing module 500 according to one embodiment of the invention. When executing this exemplary billing module 500, the system first proceeds to Step 501, where it accesses appropriate user settings that have been pre-defined by the title requester (e.g., on a user preferences screen), or indicated within the payoff proposal created by the new payoff proposal sub-module 220 to determine how the title requester prefers to be billed for payments made via the lien payoff system 5. If the title requester prefers to pay for the services provided by the lien payoff system 5 on a per payoff proposal basis, the system advances to Step 502 where it receives a fund transfer from the title requester (e.g., via funding agency or other funding source). Next, at Step 503, the system stores an indication that the payment was received. The system ends execution of the billing module 500 at Step 504.

If the user prefers to be billed periodically for the use of the lien payoff system 5, at Step 505, the billing module 500 stores the fees due for using the lien payoff system 5 (including any payments made by the system) into a file for each title requester. Next, at Step 507, the billing module 500 generates periodic bills, such as monthly bills, that include the fees stored in the file for the time period for each title requester and transmits the respective bills to each title requester. Next, at Step 509, the system tracks and records payments for the various bills in a manner known in the art. The system ends execution of the billing module 500 at Step 511.

Exemplary Operation of the System

In one embodiment, a user accesses the system via the Internet by entering an appropriate web address into their web browser. According to one embodiment, the system then displays a web page that includes a login dialog window, such as the exemplary login dialog window shown in FIG. 13. The exemplary login dialog window 600 shown in FIG. 13 includes a text box 602 for receiving a user's user ID, a text box 603 for receiving a user's password, and a login button 604 for allowing existing users to log into the system. The user enters the user ID and password into the appropriate text boxes 602, 603 and selects the login button 604. In an alternative embodiment, which is not shown, the login dialog window 600 may also include a button that allows the user to create a new account.

As described above, after the user successfully logs into the system, the system displays a main menu dialog window, such as the exemplary main menu dialog window 575 shown in FIG. 14A. As may be understood from this figure, the main menu dialog window 575 may include: (1) an “Outstanding Submissions” button 579; (2) a “Completed Submissions” button 580; and (3) a “Summary of Completed Submissions” button 581. The main menu dialog window 575 further includes a “Profile” tab 582, which, if selected, allows the user to change or view the user's user settings and preferences. In another embodiment shown in FIG. 14B, the main menu dialog window 576 further includes a “New Submissions” button 583, for allowing users to enter new lien payoff requests. The functionality of these various aspects of the main menu dialog window are described in greater detail below.

Outstanding Submissions Button

In response to the user selecting the “Outstanding Submissions” button 579 from the main menu dialog window 575, 576, the system displays an outstanding submissions dialog window, such as the outstanding submissions dialog window 625 shown in FIG. 15A. If the user is a title requester (e.g., an insurance adjuster), the outstanding submissions dialog window 625 includes a list of the outstanding, or “pending”, payoff proposals entered by the particular title requester. Similarly, if the user is a lien holder, the outstanding submissions dialog window 625 displays a list of the pending payoff proposals that have been submitted for consideration by the particular lien holder.

According to one embodiment, for each payoff proposal, the outstanding submissions dialog window 625 displays: (1) a system reference number that identifies the particular payoff proposal; (2) the name of the title requester (e.g., insurance company) that submitted the payoff proposal; (3) the name of the lender or financial institution that submitted the payoff proposal; (4) the number of days since the payoff proposal was first submitted to the system; (5) the present status of the payoff proposal; (6) the number of days that the payoff proposal has had its present status; (7) the internal reference number of the title requester (e.g., claim number) that submitted the payoff proposal; (8) the internal reference number of the lien holder (e.g., loan or lease number); (9) the name of the person or entity associated with the title (e.g., customer name); and/or (10) a chat indicator (which is discussed below in relation to FIG. 15B).

According to one embodiment, the system is configured to allow a user to view a subset of pending requests in the outstanding submissions dialog window 625 by entering appropriate filter criteria into the system. For example, the system may allow the user to filter by: (1) date range; (2) status; and/or (3) duration of days within a particular status type. For example, the system may be configured to accept, from the user, a date range during which pending requests were submitted to the system, such as, for example, by entering a start date and an end date (e.g., into date range fields 641). In another example, the user can enter a type of status and a range of number of days that pending requests have been in the status type (e.g., into fields 643 for receiving number of days within a status and the status). For example, the user can enter “Submitted” as the type of status, “2” as the least number of days within that status, and “5” as the greatest number of days within the status, and, in response to requesting that the system apply the filtering criteria (e.g., by selecting an “Apply Filters” button 645), the system displays all of the user's pending requests that have had the status of “Submitted” for between 2 and 5 days.

As mentioned above, in one embodiment, the outstanding submissions dialog window 625 displays a chat indicator for each payoff proposal. FIG. 15B illustrates an exemplary chat symbols legend 640 that may be displayed, according to various embodiments, in the outstanding submissions dialog window 625. According to one embodiment, the chat indicator column may be empty, which indicates that no comments have been entered by either party into the particular payoff proposal, or the column may include a chat symbol indicating that: (1) no new comments are pending review (e.g., a yellow circle); (2) new comments are pending review (e.g., a red circle); or (3) another party associated with the particular payoff proposal is actively drafting a comment for the particular payoff proposal (e.g., a red, blinking circle).

In addition to the above, according to one embodiment, the user can select a particular pending payoff proposal from the list of pending payoff proposals in order to view additional details about the particular pending payoff proposal or to enter additional information into the payoff proposal.

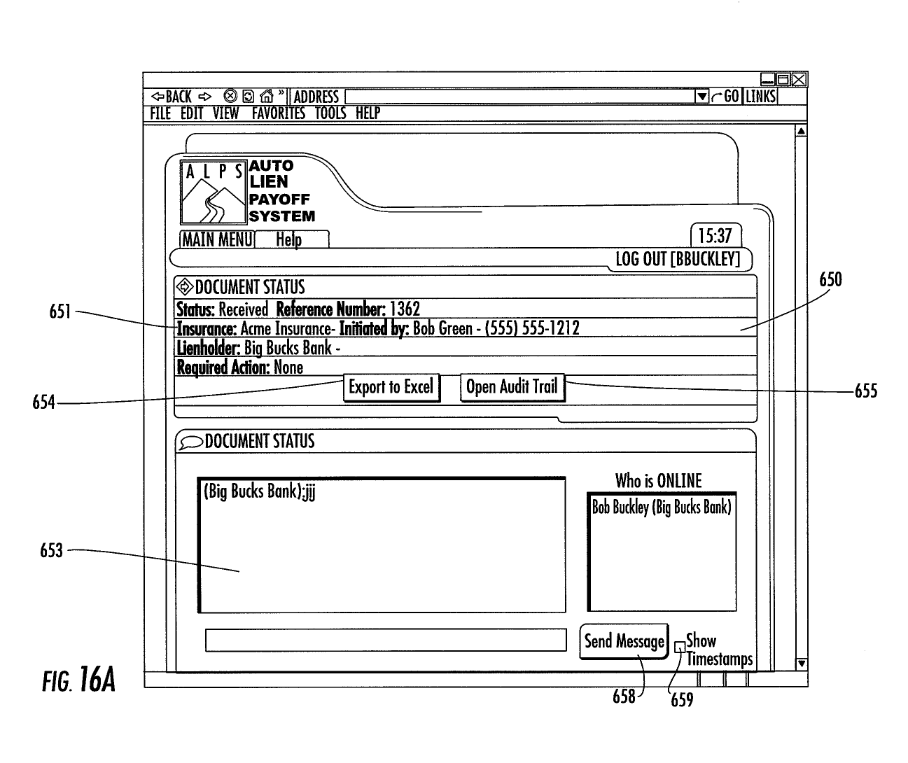

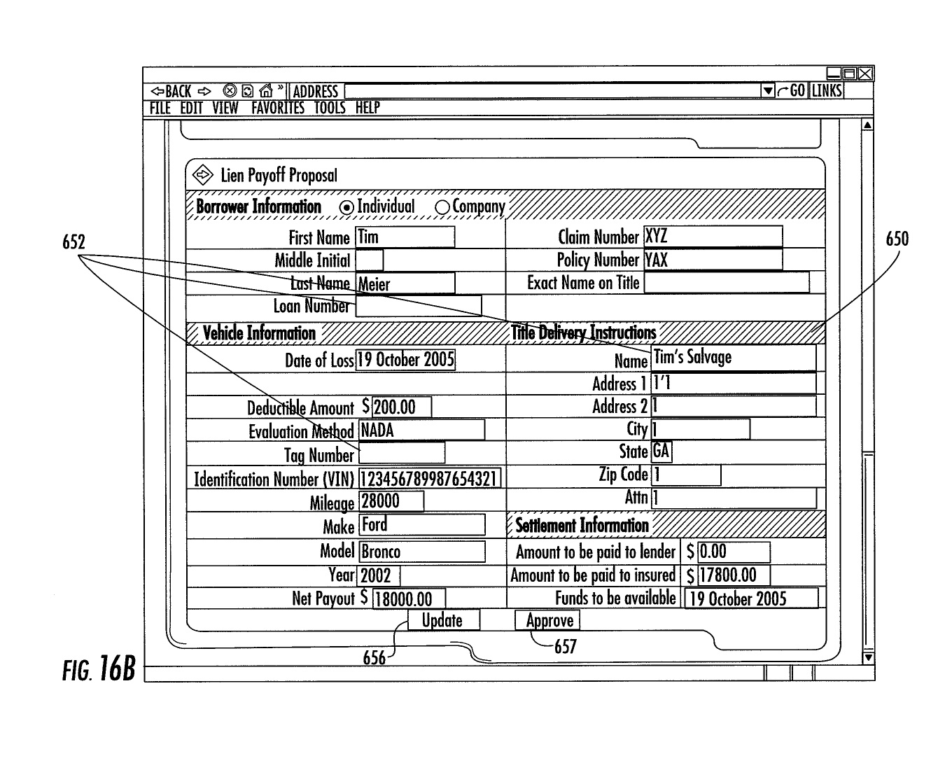

Upon the selection of a particular payoff proposal, the system displays a lien payoff proposal dialog window, such as the exemplary lien payoff proposal dialog window 650 shown in FIGS. 16A and 16B. The lien payoff proposal dialog window 650 may include, for example, information pertaining to the particular selected payoff proposal. According to the embodiment shown in FIGS. 16A and 16B, the lien payoff proposal dialog window 650 includes a summary section 651 that lists, for example, the status, system reference number, title requester, user initiating the payoff proposal, lien holder, and/or any required action for the user viewing the lien payoff proposal dialog window 650.

In addition, the lien payoff proposal dialog window 650 may include various text boxes 652 and/or drop down boxes (not shown) for receiving information from the user. For example, the lien payoff proposal dialog window 650 may include text boxes 653 for receiving and displaying comments regarding the particular payoff proposal (e.g., a “Document to Document Chat™” text box) and text boxes 652 for receiving information used to process the payoff proposal. Furthermore, according to one embodiment, the lien payoff proposal dialog window 650 further provides a “show timestamps” check box 659, which if checked by the user instructs the view/edit payoff proposal sub-module 260 to display time stamps and/or the user ID or user names associated with each previous comment associated with the payoff proposal.

In a further embodiment, the lien payoff proposal dialog window 650 is configured to “gray out,” or not allow changes to, text in text boxes and drop down boxes associated with information that is not allowed to be entered or changed by the particular user. For example, the system may gray out the text boxes 652 associated with the payoff amount when the current user is a title requester. In another example, the system may gray out any text boxes 652 that display values that are automatically calculated by the system based on other values, such as the settlement amount to be paid to the insured, which is based on the insured's deductible, the ACV, and the total payoff amount.

In various embodiments, the payoff proposal dialog window 650 may include: (1) a “Re-Submit Request” button (not shown), which allows a title requester to resubmit the payoff proposal to the lien holder, (2) an “Update” button 656, which allows the user to save a draft of the payoff proposal but does not submit the payoff proposal to other parties associated with the payoff proposal; (3) a “Delete Proposal” button (not shown), which deletes the payoff proposal; (4) an “Attach Document” button (not shown), which allows the user to attach one or more documents to the payoff proposal, and (5) an “Approve” button 657, which allows a lien holder to approve the current payoff proposal.

Furthermore, the lien payoff proposal dialog window 650 may include an export data button 654 (see FIG. 16A) that instructs the system to export information related to the particular payoff proposal to an external application, such as Microsoft Excel®, and an open audit trail button 655 that instructs the system to open another dialog window (not shown) listing an audit trail for the particular payoff proposal.

Completed Submissions Button

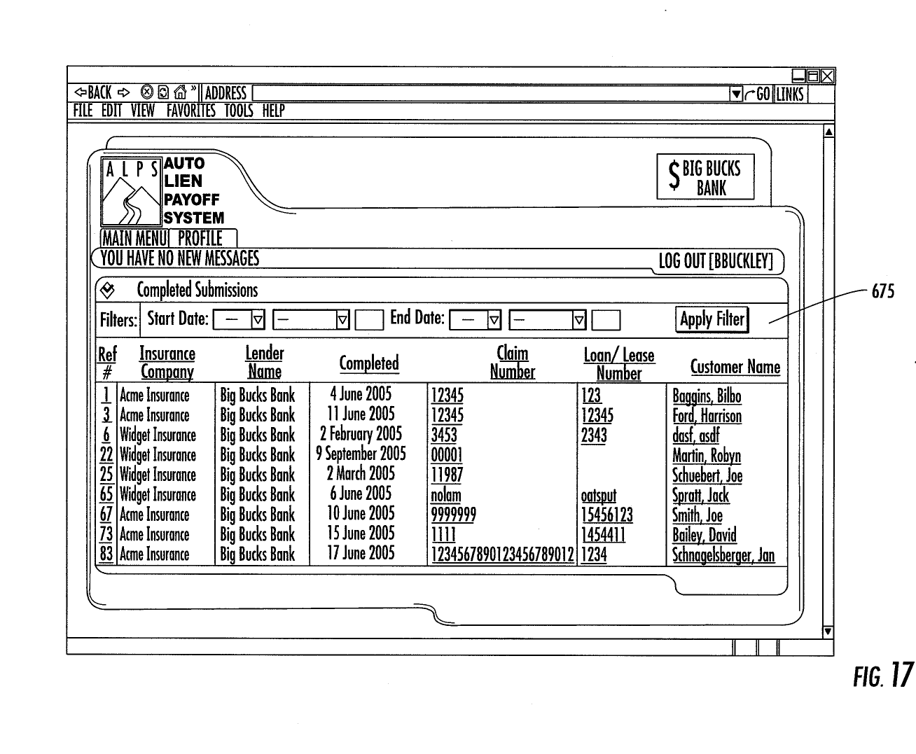

When the user selects the “Completed Submissions” button 580 from the main menu dialog window 575, 576 shown in FIGS. 14A and 14B, the system may display a completed submissions dialog window such as the exemplary completed submissions dialog window 675 shown in FIG. 17. Like the outstanding submissions dialog window 625 described above in relation to FIG. 15A, the user can select a particular completed payoff proposal listed within the completed submissions dialog window 675. In response to the user selecting a particular payoff proposal, the system displays a completed submissions dialog window (not shown) that includes detailed information for the selected completed payoff proposal.

New Submissions Button

In accordance with a particular embodiment of the invention, the main menu dialog window 576 shown in FIG. 14B further includes a “New Submissions” button 583 when the user is a title requester. Upon selection of the “New Submissions” button 583, the system displays a new payoff proposal dialog window such as the new payoff proposal dialog window 677 shown in FIG. 19B. The new payoff proposal dialog window 677, which may be similar to the lien payoff proposal dialog window 650 shown in FIGS. 16A and 16B, includes text boxes 652 and/or drop down boxes to receive various information needed to create a new lien payoff proposal. For example, the user may enter the VIN number of a vehicle into the appropriate text box and select the lien holder that holds the title for the vehicle from a list displayed in a drop down box. A new payoff proposal dialog window 677 according to one embodiment further includes a “Submit” button 690, a “Save” button 691, a “Delete” button 692, and an “Attach Document” button 693, which operate similarly to the buttons described above in relation to FIGS. 16A and 16B.

“Summary of Completed Submissions” Button

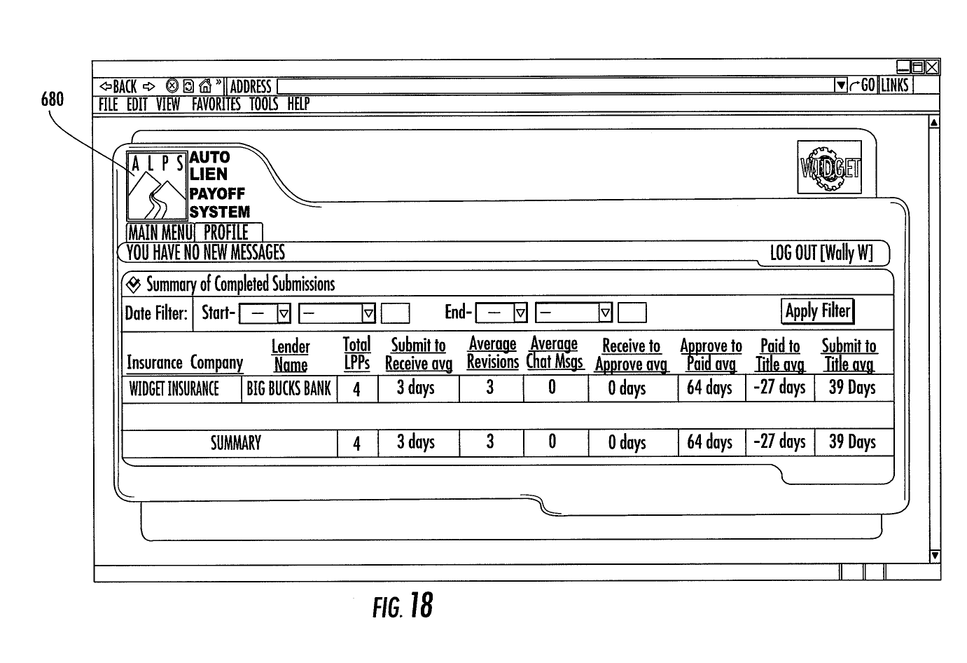

In various embodiments of the invention, in response to a user selecting the “Summary of Completed Submissions” button 581 shown in FIGS. 14A and 14B, the lien payoff system displays a “Summary of Completed Submissions” dialog window, such as the “Summary of Completed Submissions” dialog window 680 shown in FIG. 18. A summary of completed submissions dialog window 680 may list, for example: (1) the total number of payoff proposals entered by a particular title requester and submitted to a particular lien holder; (2) the average number of days between the date the payoff proposals were submitted by the title requester and the date the payoff proposals were received by the lien holder; (3) the average number of revisions to the payoff proposals; (4) the average number of chat messages entered for the payoff proposals; (5) the average number of days from the date the payoff proposal was received by the lien holder to the date the payoff proposal was approved by the lien holder; (6) the average number of days between the date the payoff proposal was approved by the lien holder and the date the payoff proposal was paid by the title requester; (7) the average number of days between the date the funds were paid by the title requester and the date the title was received by the title requester, and (8) the average number of days between the date the payoff proposal was submitted by the title requester and the date the title was received by the title requester.

Exemplary Flow of a Payoff Proposal Transaction According to One Embodiment

In order to further illustrate the operation of a system according to various embodiments of the invention, an exemplary transaction flow will now be described with reference to FIGS. 13-19, and in the context of an insurance company seeking to: (1) pay off a loan on an insured vehicle that has been “totaled”; and (2) acquire the title to the vehicle.

As noted above, in a particular embodiment of the invention, a user associated with the insurance company (the “title requester”) first logs into the system as described above. In response to the title requester logging into the system, the system displays a main menu dialog window, such as the main menu dialog window 576 shown in FIG. 14B. To enter a new payoff proposal, the title requester selects the “New Submissions” button 583 from within the main menu dialog window 576. In response, the system displays a new payoff proposal dialog window, such as the new payoff proposal dialog window 677 shown in FIG. 19B. Next, the title requester enters information into the new payoff proposal dialog window 677, such as: (1) the lien holder; (2) the name of the insured; (3) the date of loss of the vehicle; (4) a deductible amount for the vehicle; (5) the actual cash value of the vehicle (ACV); (6) the evaluation method used to determine the vehicle's ACV; (7) the vehicle's vehicle identification number (VIN); (8) the vehicle's current odometer reading; (9) the vehicle's make, model, and year; (10) the insurance company's claim number for the vehicle; (11) the loan policy number for the vehicle; and/or (12) title delivery instructions (e.g., name of the entity to receive title, the entity's address, and/or an indication of particular personnel within the entity to receive the title).

In addition, the title requester can initiate an online exchange of comments (e.g., an online “chat”) with other users associated with the payoff proposal (e.g., with a representative of the lender that currently holds title to the vehicle). This exchange of comments may either occur in real time (if both parties are online and available to exchange comments regarding the proposal), or over a longer period of time (e.g., if the party who is receiving a comment is unavailable at the time that the comment is transmitted).

To initiate an online exchange of comments, the title requester may enter comments into a comment text box, such as the comment text box 653 shown in FIG. 19A. For example, the title requester may request that the lien holder provide certain information and/or documents to the title requester, such as a copy of the title or a copy of a guarantor's letter. After entering appropriate comments into the text box, the title requester submits the message for review by the lien holder by selecting the “send message” button 658. In response to the user selecting the send message button 658, the system receives and stores the comments entered by the user. In one embodiment, the system then notifies the lien holder that a message regarding the payoff proposal is pending in the system for their review. The lien holder may then either respond immediately (e.g., in real time), or at a later time.

Returning to FIG. 19B, upon completing the entry of information for the new payoff proposal into the new payoff proposal dialog window 677, the user selects the “submit” button 690 and, in response, the system receives and stores the information in the system's database. After the user submits the new payoff proposal (or saves the new payoff proposal as described above in regard to FIGS. 16B and 19B), the system returns the user to the main menu dialog window 576 to, for example: (1) enter additional payoff proposals: (2) access outstanding or completed submissions; or (3) log out of the system.

In various embodiments, in response to receiving a new payoff proposal from a title requester, the system is configured to notify the lien holder identified in the new payoff proposal (e.g., via email) that the lien holder has a new payoff proposal pending in the system. To view the newly submitted payoff proposal, a user associated with the lien holder (the “lien holder”) accesses the system via the Internet and logs in as described above. In response to verifying that the lien holder has access to the system, the system presents a main menu dialog window to the user, such as the main menu dialog window 575 shown in FIG. 14A. Next, the lien holder selects the “Outstanding Submissions” button 579 to view any pending payoff proposals that have been made to lien holder.

In response to the lien holder selecting the “Outstanding Submissions” button, the system displays an outstanding submissions dialog window, such as the outstanding submissions dialog window 625 shown in FIG. 15A, which lists all (or substantially all) of the lien holder's pending payoff proposals within the system. In various embodiments, the system is adapted to allow the lien holder to view pending payoff proposals, as described above in regard to FIG. 15A, and/or select one of the outstanding payoff proposals to view and/or edit. In response to the user selecting a particular payoff proposal, the system displays a lien payoff proposal window, such as the lien payoff proposal window 650 shown in FIGS. 16A and 16B, which includes detailed information about the selected payoff proposal.

Next, the user reviews the information for the payoff proposal in the lien payoff proposal window 650 and may optionally enter additional information regarding the payoff proposal into the lien payoff proposal window 650. For example, the user may enter the loan number associated with the lien, the exact name listed on the vehicle title, and the payoff amount for the vehicle. If the lien holder is not ready to approve the payoff proposal, but wants to save the new information entered to the system and make the new information available to the title requester, the user selects the “update” button 656. In response, the system receives and stores the information entered by the user. In addition, according to one embodiment, in response to receiving edits to the payoff proposal from the lien holder, the system is configured to notify (e.g., via email) the title requester identified in the payoff proposal that the lien holder has edited the payoff proposal. Upon saving the payoff proposal, the lien holder can return to the main menu dialog window 575 to view and edit additional payoff proposals, to access completed submissions, or to log out of the system.

In addition to being configured to allow a lien holder to enter and save new information for association with the payoff proposal, the system may be further configured to allow the lien holder to review comments entered by the title requester and enter comments to be displayed to the title requester regarding the particular payoff proposal. For example, the lien holder may enter a comment into the comment text box 653: (1) requesting that the title requester make the payoff funds available at an earlier date than specified in the payoff proposal; or (2) requesting that the title requester enter a missing zip code for the address to which the title should be mailed. To enter and transmit comments to the title requester, the lien holder may type comments into the comment text box 653 and select the “send message” button 658.

In addition, the system may be configured to allow the lien holder to post copies of one or more documents (such as a copy of the requested title or a guarantor's letter) to the system for later viewing by the title requester when the title requester views the payoff proposal.

To review the edited payoff proposal, the title requester selects the outstanding submissions button 579 from the main menu dialog window 576, and the system displays the outstanding submissions dialog window 625. The title requester then selects the particular payoff proposal, and the system displays the edited payoff proposal within the lien payoff proposal window 677.

The title requester then reviews edited payoff proposal, including any comments entered by the lien holder into the comment text box 653 and/or any new documents posted to the system in conjunction with the payoff proposal. The title requester may then edit the payoff proposal, respond to any comments posted by the lien holder, and/or post any additional documents to the system for later viewing by the lien holder. The title requester then resubmits the modified payoff proposal.

The lien holder may then review the modified payoff proposal. In various embodiments, the lien holder and title requester continue exchanges of information as discussed above until, for example, the lien holder approves the transaction within the system in the manner described above.

In response to receiving an indication from the lien holder that the payoff proposal has been approved, the system facilitates the transfer of the funds agreed to within the payoff proposal and/or a transfer of the title as discussed in greater detail above.

### CONCLUSION

Many modifications and other embodiments of the invention will come to mind to one skilled in the art to which this invention pertains having the benefit of the teachings presented in the foregoing descriptions and the associated drawings. For example, while various examples are described above in regard to the payoff of a vehicle loan or lease, the system may be configured to facilitate other types of transactions, such as the payoff of other types of loans or financial obligations. Accordingly, it is to be understood that the invention is not to be limited to the specific embodiments disclosed and that modifications and other embodiments are intended to be included within the scope of the invention. Although specific terms are employed herein, they are used in a generic and descriptive sense only and not for the purposes of limitation.

What is claimed is:

1. A lien payoff computer system for facilitating the payoff of a financial obligation that is secured by a lien on an item, said lien payoff computer system comprising:
a computer processor; and
memory for storing computer-readable instructions to be executed by said computer processor, wherein said lien payoff computer system is adapted for:
receiving a payoff proposal from a title requester, said payoff proposal comprising one or more terms according to which said title requester proposes to pay off said particular financial obligation;
in response to receiving said payoff proposal from said title requester, notifying a lien holder associated with said financial obligation that said payoff proposal is available for review; and
after notifying said lien holder that said payoff proposal is available for review, displaying one or more terms of said payoff proposal to said lien holder.

2. The lien payoff computer system of claim 1, wherein:
said payoff proposal comprises a payoff amount of said financial obligation; and
said lien payoff computer system is further configured for:
receiving, from said lien holder, an approval of said payoff proposal; and
in response to receiving said approval of said payoff proposal from said lien holder, facilitating the transfer of funds from said title requester to said lien holder.

3. The lien payoff computer system of claim 2, wherein said lien payoff computer system is further configured for, in response to said funds being transferred from said title requestor to said lien holder, notifying said lien holder that said transfer has been completed.

4. The lien payoff computer system of claim 2, wherein said lien payoff computer system is further configured for, in response to said funds being transferred from said title requester to said lien holder, notifying said title requestor that said transfer has been completed.

5. The lien payoff computer system of claim 2, wherein said step of facilitating the transfer of funds from said title requestor to said lien holder comprises generating a funding request for said payoff amount to be paid by said title requestor to said lien holder.

6. The lien payoff computer system of claim 5, wherein said step of facilitating the transfer of funds from said title requestor to said lien holder comprises sending said funding request to a financial institution associated with said lien holder.

7. The lien payoff computer system of claim 2, wherein said step of facilitating the transfer of funds from said title requestor to said lien holder comprises generating a funding request for said payoff amount to be paid by said title requestor to said lien holder.

8. The lien payoff computer system of claim 2, wherein said step of facilitating the transfer of funds from said title requester to said lien holder comprises facilitating the electronic transfer, of a payoff amount to be paid by said title requester to said lien holder, from a financial institution associated with said title requester to said lien holder.

9. The lien payoff computer system of claim 1, wherein said lien payoff computer system is further adapted for facilitating a written electronic exchange of comments between said title requester and said lien holder.

10. The lien payoff computer system of claim 9, wherein said lien payoff computer system is configured for facilitating said written electronic exchange of comments substantially in real time.

11. The lien payoff computer system of claim 1, wherein said lien payoff computer system is adapted for facilitating the transfer of an electronic copy of one or more documents associated with said payoff proposal from said title requester to said lien holder.

12. The lien payoff computer system of claim 11, wherein said one or more documents comprise one or more documents selected from a group consisting of: (1) a guarantor's letter; and (2) a copy of a title to said item.

13. The lien payoff computer system of claim 1, wherein said item is a vehicle.

14. The lien payoff computer system of claim 1, wherein said lien payoff computer system is further adapted for:
receiving automatic payoff criteria from said lien holder;
determining whether said payoff proposal satisfies said automatic payoff criteria; and
in response to determining that said particular payoff proposal satisfies said automatic payoff criteria, approving said payoff proposal substantially without input from a human user.

15. The lien payoff computer system of claim 14, wherein said step of approving said payoff proposal substantially without input from a human user comprises approving said payoff proposal entirely without input from a human user.

16. The lien payoff computer system of claim 1, wherein said lien payoff computer system is further adapted for:
determining whether an actual cash value of said item is greater than a payoff amount of said financial obligation; and
in response to determining that said actual cash value of said item is greater than said payoff amount of said financial obligation, automatically approving said payoff proposal.

17. The lien payoff computer system of claim 1, wherein said lien payoff computer system is further adapted for:
determining whether an actual cash value of said item is within a predetermined tolerance of a payoff amount of said financial obligation; and
in response to determining that said actual cash value of said item is within said predetermined tolerance of said payoff amount of said financial obligation, automatically approving said payoff proposal.

18. The lien payoff computer system of claim 1, wherein said lien payoff computer system is further adapted for:
retrieving information regarding said item from an external computer system, said external computer system being geographically remote from said lien payoff computer system;
integrating said information into said payoff proposal to create a supplemented payoff proposal; and
displaying said supplemented payoff proposal to a user.

19. The system of claim 18, wherein said information comprises the actual cash value of said item.

20. The system of claim 19, wherein:
said external computer system is a computer system that is associated with said lien holder.

21. The system of claim 18, wherein said information comprises an identification number associated with said financial obligation.

22. The system of claim 21, wherein:
said external computer system is a computer system that is associated with said lien holder.

23. A method of providing a computer system that is adapted to facilitate the structured communication, and the exchange of documents between (A) a requester of a title to a particular item of property, and (B) a lien holder, to facilitate:
(A) the payoff of a loan;
(B) the release of a lien on said title, said lien being used to secure said loan; and
(C) the transfer of a physical embodiment of said title to the title requester.

24. The method of claim 23, wherein said physical embodiment of said title is a paper title.

25. The method of claim 23, wherein said computer system is adapted to facilitate a transfer of a payoff proposal from the said requestor of said title to said lien holder.

26. The method of claim 23, wherein said computer system is adapted to allow users to engage in an on-line chat to facilitate expedited processing of a particular lien payoff transaction.

27. The method of claim 23, wherein said computer system is configured to allow users to post messages to an electronic message board to facilitate expedited processing of a particular lien payoff transaction.

28. The method of claim 27, wherein said computer system is configured to automatically notify a user in response to a new comment being posted on the electronic message board in regard to a particular lien payoff transaction.

29. The method of claim 23, wherein said computer system is adapted to:
assign a respective current transaction status to each of a plurality of lien payoff transactions that are pending in said computer system, and
allow users to search said plurality of lien payoff transactions by transaction status.

30. The method of claim 23, wherein said computer system is adapted to automatically determine whether to approve one or more particular lien payoff proposals based on whether said one or more lien payoff proposals satisfy a set of pre-determined automatic payoff criteria.

31. The method of claim 23, wherein said computer system is adapted to:
automatically generate an electronic funding request for a payoff amount of said loan to be paid by said title requestor to said lien holder; and
send this electronic funding request to a third-party funding agency holding funds on behalf of said title requestor.

32. The method of claim 23, wherein said computer system is configured to interface with at least one remote computer system to retrieve information for use in completing approval of a payoff request made by said title requester to said lien holder to pay off said loan.

33. The method of claim 32, wherein said information comprises the actual cash value of said particular item of property.

34. The method of claim 32, wherein said information comprises a deductible amount associated with said particular item of property.

35. The method of claim 32, wherein:
said particular item of property is a vehicle; and
said information comprises the make, model, year, owner, owner address, license plate number, and description of said vehicle; and
said at least one remote computer system is a Department of Motor Vehicles computer system.

36. The method of claim 23, wherein said computer system is adapted to allow said title requester to attach at least one document to said payoff proposal for later viewing by said lien holder.

37. The method of claim 36, wherein said at least one document includes a copy of a title of said particular item of property.
